(19) United States
(12) Patent Application Publication
(10) Pub. No.: US 2026/0090950 A1
(43) Pub. Date: Apr. 2, 2026

(54) LAYERED CUSHION WITH A VIBRATING ELECTROMECHANICAL DEVICE

(71) Applicant: Dame Products, Inc., Brooklyn, NY (US)

(72) Inventors: Julia F. Lopez, New York, NY (US); Elizabeth Ayton, Rhineback, NY (US); Alexandra Fine, Brooklyn, NY (US)

(21) Appl. No.: 19/113,060

(22) PCT Filed: Sep. 21, 2023
(86) PCT No.: PCT/US2023/033373

§ 371 Date: Mar. 19, 2025

Related U.S. Application Data
(60) Provisional application No. 63/408,897, filed on Sep. 22, 2022.

(51) Int. Cl. A61H 19/00; A61H 23/02

(52) U.S. Cl. CPC A61H 19/34; A61H 23/02; A61H 2201/14; A61H 2201/1633; A61H 2201/1654; A61H 2201/1697; A61H 2201/5007; A61H 2201/5097

(57) ABSTRACT

A cushion includes a body having a first portion including a first material and a second portion including a second material. The second portion is arranged on an outer surface of the first portion. A vibrator mechanism is located at at least one of the first portion and the second portion and is operable to generate vibrations detectable at a region of an exterior surface of the second portion. A control unit is operably coupled to the vibrator mechanism and is embedded within at least one of the first portion and the second portion.

### CROSS REFERENCE TO RELATED APPLICATIONS

This application claims the benefit of U.S. Provisional Patent Application No. 63/408,897, filed Sep. 22, 2022, which is incorporated herein by reference in its entirety.

### TECHNICAL FIELD

This disclosure relates to the field of sexual stimulation. More particularly to vibrating furniture, and in particular to a cushion, pillow, or other type of furniture that includes a vibration device or a system that transmits vibrations.

### BACKGROUND

Vibrating electromechanical devices, sometimes referred to as vibrators, can be used to help facilitate women reaching orgasm. Couples may also choose to use a vibrator to enhance the pleasure of one or both partners. One existing type of vibrator is a saddle-style vibrator that a user straddles while the vibrator is positioned on a surface. There remains a need for an improved saddle-style vibrator to provide improved comfort during use thereof.

### SUMMARY

According to an embodiment, a cushion includes a body having a first portion including a first material and a second portion including a second material. The second portion is arranged on an outer surface of the first portion. A vibrator mechanism is located at at least one of the first portion and the second portion and is operable to generate vibrations detectable at a region of an exterior surface of the second portion. A control unit is operably coupled to the vibrator mechanism and is embedded within at least one of the first portion and the second portion

In addition to one or more of the features described herein, or as an alternative, in further embodiments the second portion is directly on the outer surface of the first portion.

In addition to one or more of the features described herein, or as an alternative, in further embodiments the vibrator mechanism is adjacent to the second portion.

In addition to one or more of the features described herein, or as an alternative, in further embodiments the second material is a foam.

In addition to one or more of the features described herein, or as an alternative, in further embodiments the second material is a viscoelastic foam having an indentation load deflection of 40 ILD to 60 ILD.

In addition to one or more of the features described herein, or as an alternative, in further embodiments including a rigid structure at the exterior surface of the second portion, wherein the rigid structure comprises a transmissible surface.

In addition to one or more of the features described herein, or as an alternative, in further embodiments the control unit further comprises an input, the input being accessible via the exterior surface of the second portion.

In addition to one or more of the features described herein, or as an alternative, in further embodiments the control unit includes an input and the input is a remote input.

In addition to one or more of the features described herein, or as an alternative, in further embodiments including a cover removably mountable about the second portion.

In addition to one or more of the features described herein, or as an alternative, in further embodiments the cover has an indicator operable to identify a location of the input.

In addition to one or more of the features described herein, or as an alternative, in further embodiments in which the cover comprises at least one of a cotton, polyester, or linen.

According to an embodiment, a cushion includes a body having a rigid structure. A portion of the rigid structure is located at an exterior of the body and includes a transmissible surface. A vibrator mechanism is located within the body. The rigid structure is mechanically coupled to the vibrator mechanism such that vibrations generated by the vibrator mechanism are detectable at the transmissible surface. A control unit is positioned within the body and is operably coupled to the vibrator mechanism.

In addition to one or more of the features described herein, or as an alternative, in further embodiments the body comprises a top surface and the transmissible surface is located at the top surface.

In addition to one or more of the features described herein, or as an alternative, in further embodiments the rigid structure includes a polymeric material.

In addition to one or more of the features described herein, or as an alternative, in further embodiments the rigid structure includes at least one of a thermoplastic or a thermoset.

In addition to one or more of the features described herein, or as an alternative, in further embodiments the body comprises a first portion and a second portion, the second portion being positioned on the first portion. The second portion includes a foam having an indentation load deflection of 40 ILD to 60 ILD.

In addition to one or more of the features described herein, or as an alternative, in further embodiments the second portion is a polyurethane foam.

According to an embodiment, a method of manufacturing a cushion includes providing a body having a first portion and a second portion. The second portion is arranged on the first portion. The method additionally includes disposing a vibrator mechanism within at least one of the first portion or the second portion. The vibrator mechanism is operable to generate vibrations detectable at a region of an outer surface of the second portion. The method also includes coupling a control unit to the vibrator mechanism.

### BRIEF DESCRIPTION OF THE DRAWING(S)

The following descriptions should not be considered limiting in any way. With reference to the accompanying drawings, like elements are numbered alike:

FIG. 1A is a front perspective view of an embodiment of a cushion;

FIG. 1B is a rear perspective view of the cushion of FIG. 1A according to an embodiment;

FIG. 2A is a cross-sectional view of the cushion of FIG. 1A according to an embodiment;

FIG. 3 is front perspective view of the cushion of FIG. 1A according to an embodiment;

FIG. 4 is a rear perspective view of another embodiment of a cushion;

FIG. 5 is a side view of the cushion of FIG. 4 according to an embodiment;

FIG. 6 is a cross-sectional view of the cushion of FIG. 4 according to an embodiment;

FIG. 7 is a schematic depiction of an embodiment of a control system of the cushion according to an embodiment; and

FIG. 8 is a side view of the cushion of FIG. 4 with a cover according to an embodiment.

### DETAILED DESCRIPTION

A detailed description of one or more embodiments of the disclosed apparatus is presented herein by way of exemplification and not limitation with reference to the Figures.

Described herein is a device for providing sexual stimulation to a user. The device is configured to support the user when used in a straddle configuration to assist in providing sexual stimulation. Disclosed is a vibrating cushion. In an embodiment, the vibrating cushion comprises at least one layer of a cushioned material and comprises a first portion encapsulated within a second portion to provide a multiple-layered cushion. The multiple-layered configuration provides enhanced support for the user, resulting in improved comfort. In an embodiment, the vibrating cushion further comprises a rigid structure. The rigid structure is exposed at the surface of the vibrating cushion. The rigid structure may be operably coupled to an electromechanical vibrator mechanism capable of producing vibrations. The device further contains a control unit to operate the device and may comprise a cover that is removably mounted to the cushion.

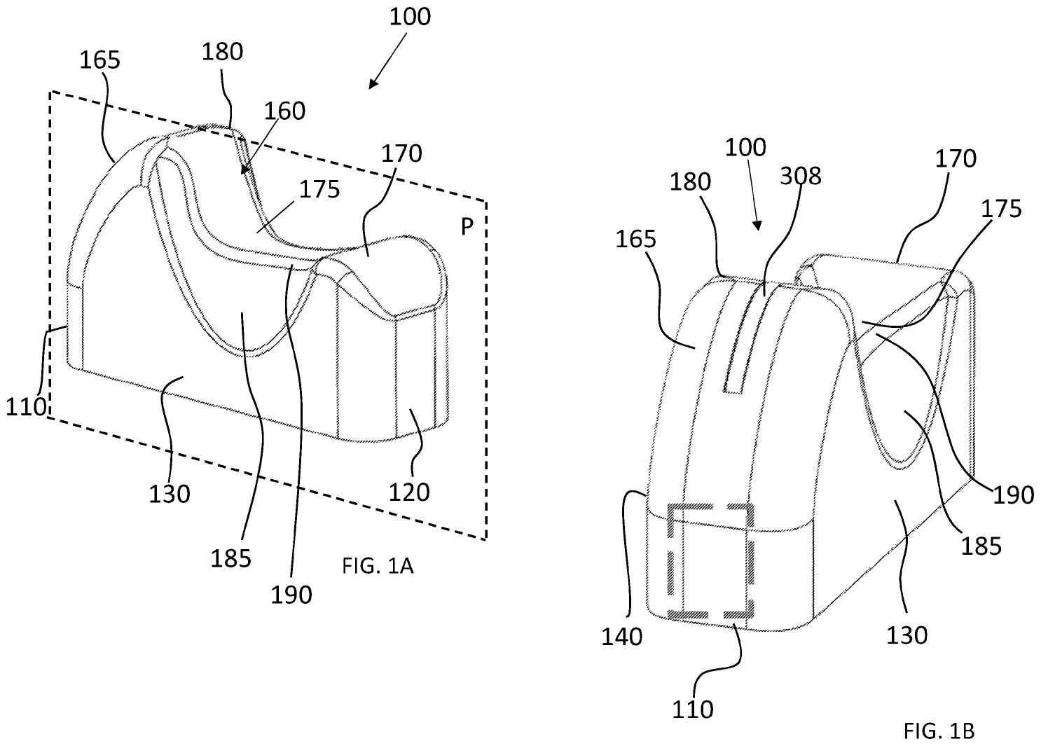

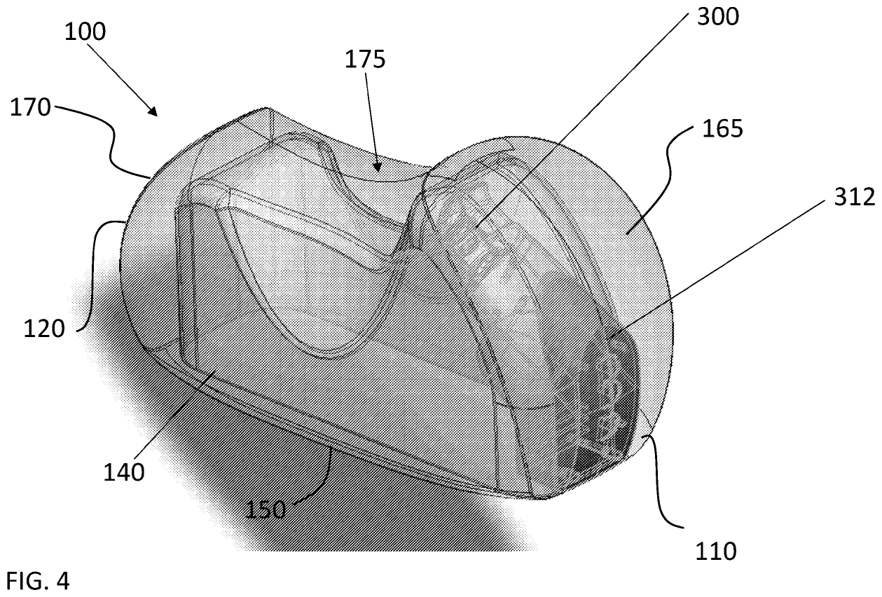

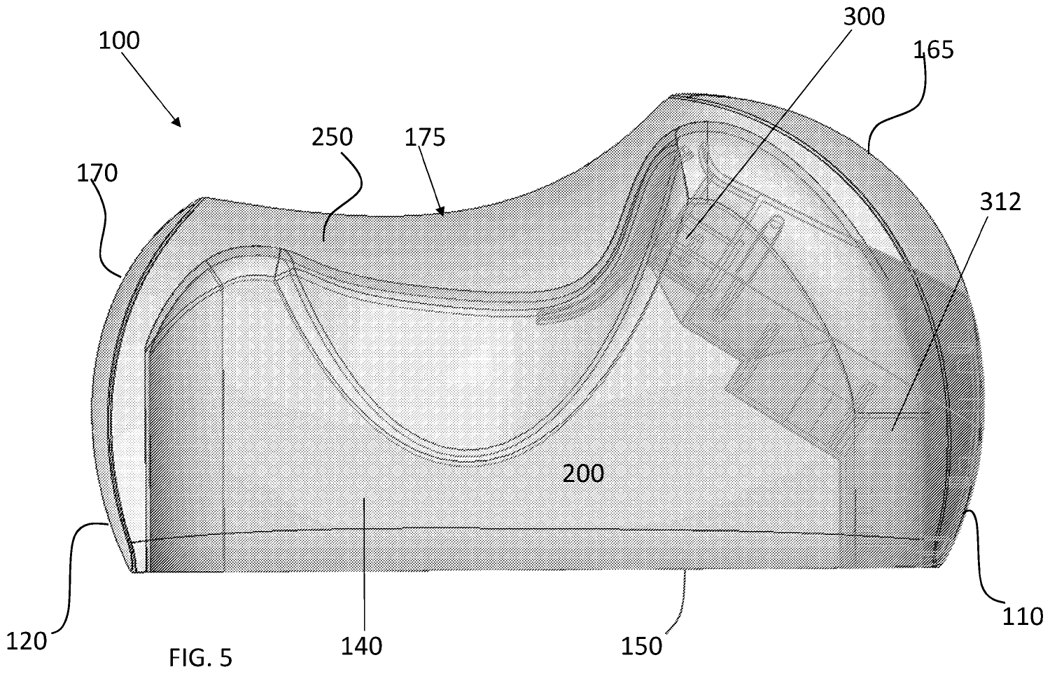

With reference now to the FIGS., an embodiment of a cushion operable to stimulate a body part, such as clitoris, is illustrated. As shown in FIGS. 1A and 1B, the cushion 100 has a body comprising a first end 110 and a second end 120. A first lateral side 130 and a second lateral side 140 are arranged opposite one another and extend between and couple the first end 110 and the second end 120, respectively. The first end 110 and the second end 120 may be oriented generally parallel to one another. In the illustrated, non-limiting embodiment of FIGS. 1-3, the first end 110 and the second end 120 have a generally vertical orientation. However, embodiments where the first and second ends 110 and 120 are not parallel to one another, such as where one or both of the first end 110 and the second end 120 has a non-vertical orientation, are also contemplated herein. For example, in the embodiment of FIGS. 4-6, the first end 110 and the second end 120 may have a curved or arcuate configuration. In an embodiment, both the first end 110 and the second end 120 have a convex curvature extending towards the opposite end of the cushion. Further, the overall height of the first end 110 and the second end 120, for example measured within a vertical plane, may be the same, or may be different. As shown, the height of the second end 120 may be less than the height of the first end 110. However, embodiments where the height of the second end 120 is greater than that of the first end 110 is also contemplated herein.

In the illustrated, non-limiting embodiment, the body may be symmetrical about a central longitudinal plane P. Accordingly, in the embodiment shown, the first lateral side 130 and the second lateral side 140 may be substantially identical opposites of one another. However, embodiments where the cushion is not symmetrical about a central longitudinal plane P are also contemplated herein. In an embodiment, the first and second lateral sides 130 and 140 may be parallel to one another and arranged in a non-vertical orientation, or alternatively the first and second lateral sides 130 and 140 may be arranged at a non-zero angle relative to one another.

The cushion additionally includes a bottom surface 150 extending between the first and second lateral sides 130 and 140 and the first and second ends 110 and 120, respectively. The bottom surface 150 may function as the base or bottom of the cushion 100 and may be configured to rest upon a support surface during use. Although the bottom surface 150 is illustrated as being generally rectangular in shape, it should be appreciated that the bottom surface 150 may have any suitable shape, and may be a circular, triangular, elliptical, or a polygonal shape, for example. It should be appreciated that the configuration of the first and second ends 110 and 120 or first and second lateral sides 130 and 140 will vary with the shape of the bottom surface 150.

The cushion comprises a top surface 160 disposed generally opposite the bottom surface 150. The top surface 160 extends between and is connected to the first and second lateral sides 130 and 140 and the first and second ends 110 and 120, respectively. In an embodiment, the top surface 160 is configured as a user surface and may be configured to intimately contact or support the user. As shown, the top surface 160 may have a non-planar configuration. As a result of the non-planar configuration of the top surface 160, the overall height of the cushion, measured in a vertical plane, may vary between the first end 110 and the second end 120. In an embodiment, the top surface 160 of the body may comprise a contour or shape configured to engage and provide stimulation to a user when the user is straddling the cushion. For example, the contour of the top surface 160 may be complementary to a portion of a user's anatomy.

In the illustrated, non-limiting embodiment of FIGS. 1-3, the top surface 160 includes a first arcuate section 165 extending from the first end 110, a second arcuate section 170 extending from the second end 120, and an intermediate section 175 positioned between and connecting the first arcuate section 165 and the second arcuate section 170. In other embodiments, such as shown in FIGS. 4-6, the first arcuate section 165 may be formed as part of or may be or integral with the first end 110 and the second arcuate section may be formed as part of, or may be or integral with, the second end 120. As shown, the curvature of the first arcuate section 165 may extend 90 degrees. However, embodiments where the first arcuate section 165 extends more than 90 degrees, or alternatively, less than 90 degrees, are also contemplated. In an embodiment, the curvature of the second arcuate section 170 extends greater than 90 degrees, such as 120 degrees for example. It should be appreciated that the curvature of the second arcuate section 170 may extend any suitable amount. In an embodiment, the first arcuate section 165 and the second arcuate section 170 each independently extend 45 to 150 degrees, 50 to 110 degrees, 60 to 100 degrees, 40 to 80 degrees, 50 to 70 degrees, 100 to 140 degrees, or 110 to 130 degrees, wherein the endpoints of the foregoing ranges may be independently selected.

The intermediate section 175 may have any suitable contour. In the illustrated, non-limiting embodiment, the intermediate section 175 has a generally smooth contour including at least one slanted or angled section. However, as shown in FIG. 1A, the surface of the intermediate section 175, may be generally linear extending in a horizontal plane between the first and second lateral sides 130 and 140, respectively.

In an embodiment, the diameter of the first arcuate section 165 is greater than the diameter of the second arcuate section 170. As a result, a maximum height at the first arcuate section 165 may be greater than a maximum height at the second arcuate section 170. Further, the maximum height of the body may be located at the distal end 180 of the first arcuate section 165.

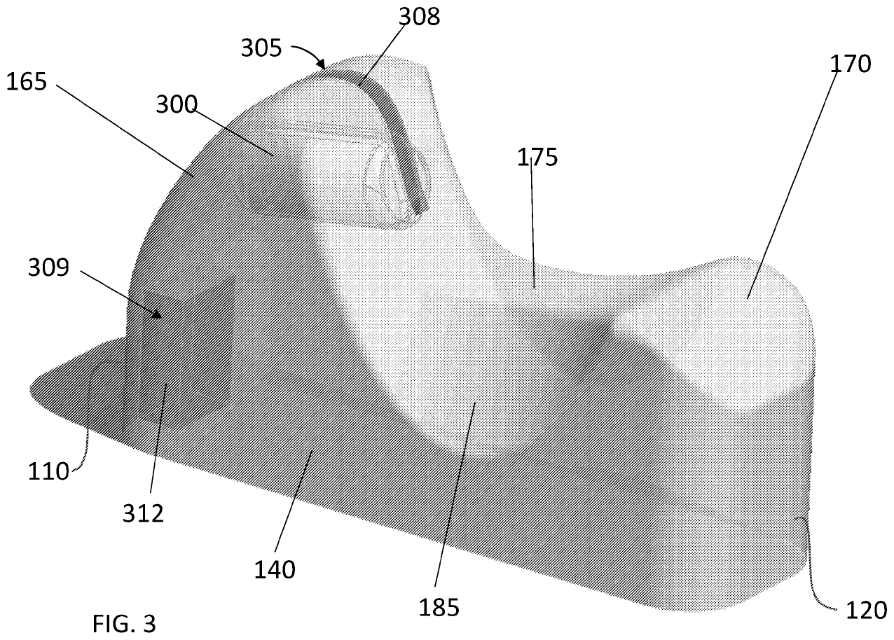

The intersection between each of the first and second ends 110 and 120, the first and second lateral sides 130 and 140, and the bottom and top surfaces 150 and 160, may comprise a radius, and a diameter of the radius may be 0.1 to 1 centimeters (cm), or 0.2 to 0.8 cm. Further, a recess 185 may be provided in a portion of at least one of the first and second lateral sides 130 and 140. While not wanting to be bound by theory, it is understood that the recess 185 contributes to the user's comfort. In the illustrated, non-limiting embodiment, the recess 185 extends from each edge 190 of the intermediate section 175 over at least a portion of the height of the first and second lateral sides 130 and 140, respectively. The recess 185 may be generally planar, or alternatively, may be curved in one or more planes. As best shown in FIGS. 1 and 3, the recess 185 may be contoured about a generally vertically oriented axis such that a width of the intermediate section 175, measured in a horizontal plane, is narrowed relative to the first and second arcuate sections. Alternatively, or in addition, the recess 185 may be curved about a generally horizontally oriented axis. Inclusion of the recess 185 may form a surface at the intersection of the first and the second sides configured to receive a portion of the user's leg, such as a thigh, when straddling the cushion.

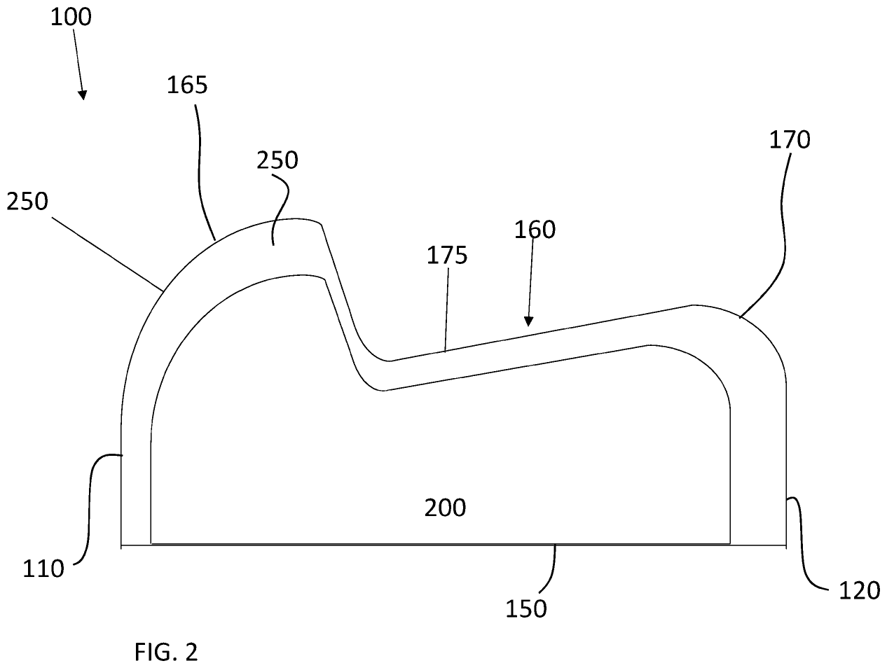

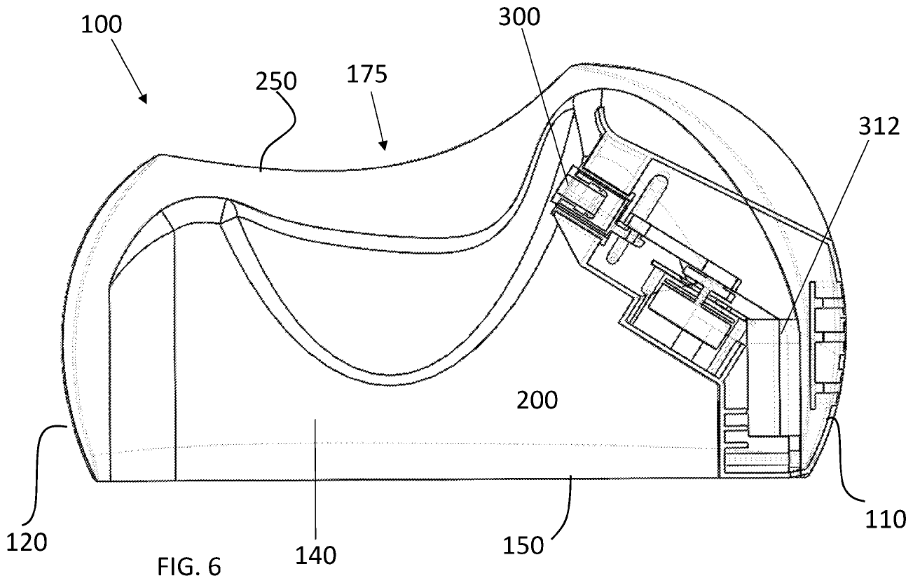

With reference now to FIGS. 2 and 6, a cross-sectional view of the various embodiments of the cushion 100 is illustrated. In the illustrated, non-limiting embodiment, the body of the cushion 100 includes a first portion 200, and a second portion 250 on an outer surface of the first portion 200. In an embodiment, the second portion 250 is directly on, or in contact with, or adjacent to, an outer surface of the first portion 200. In an embodiment, the second portion 250 may fully encapsulate the first portion 200. Alternatively, the second portion 250 may be on, or directly on, one or more selected outer surfaces of the first portion 200. In an embodiment, the second portion 250 may be on at least one of the first and second sides, the first and second ends, the top surface, or the recess.

Each of the first portion 200 and the second portion 250 may have a generally uniform thickness, or the thickness of each may vary independently. In an embodiment, an axial height of the first portion 200 and the second portion 250 may the same at any location about the cushion. Alternatively, the thickness of the first portion 200 may be greater than the thickness of the second portion 250 at one or more locations about the cushion. For example, in the illustrated, non-limiting embodiment, the first portion 200 may have a thickness of 10 to 70%, 20 to 60%, or 30 to 50% of a dimension, such as total height or a total width of the body, for example, and the second portion 250 may have a thickness of 90 to 30%, 80% to 40%, or 70% to 50%, of the dimension of the body, based on a total dimension, e.g., a total height or a total width of the body, wherein the endpoints of the foregoing ranges may be independently selected. In an embodiment, the first portion 200 has a thickness of 50 to 70% and the second portion 250 a thickness of 50% to 30%, of the total height of the body. In an embodiment, the first portion 200 has a thickness of 50 to 70%, and the second portion 250 a thickness of 50% to 30%, of a total width of the body.

The first portion 200 may comprise a first material, and the second portion 250 may comprise a second material. The first material and the second material may be the same or different. In an embodiment, the first material is more rigid than the second material, and the first material may be selected to provide structural stability to the cushion 100. In an embodiment, a modulus of the first material is greater than the second material. Accordingly, in an embodiment, the first material has a greater firmness than that of the second material. In another embodiment, the first material and the second material have a same firmness. Alternatively, the first material has a firmness which is less than a firmness of the second material. In an embodiment, the first material and the second material may each independently have an indentation load deflection (ILD) of 40 to 60 ILD, 40 to 50 ILD, 45 to 55 ILD, or 50 to 60 ILD. In embodiment, the first material is rigid, and the second material the second material has an ILD of 40 to 60 ILD, 40 to 50 ILD, 45 to 55 ILD, or 50 to 60 ILD. Indentation load deflection may be measured according to ATSM D3574.

The first material and the second material may each independently comprise a polymeric material, and may comprise at least one of a thermoplastic, or a thermoset, and may comprise at least one of an epoxy, ethylene propylene diene rubber (EPR), ethylene propylene diene monomer rubber (EPDM), melamine, polyacetal, polyacrylamide, polyacrylic, polyacrylonitrile, polyamide, polyarylene ether, polyarylene sulfide, polyarylene sulfone, polybenzoxazole, polybenzothiazole, polybutadiene, polycarbonate, polycarbonate ester, polyether ketone, polyether ether ketone, polyether ketone, polyethersulfone, polyester, polyimide, polyisoprene, polyolefin, polytetrafluoroethylene, polyphosphazene, poly(alkyl) (meth)acrylate, polystyrene, a rubber-modified polystyrene such as acrylonitrile-butadiene-styrene (ABS), styrene-ethylene-butadiene (SEB), methyl methacrylate-buadiene-styrene (MBS), polyoxadiazole, polysilazane, polysulfone, polysulfonamide, polyvinyl acetate, polyvinyl chloride, polyvinyl ester, polyvinyl ether, polyvinyl halides, polyvinyl nitrile, polyvinyl thioether, polyurea, polyurethane, polyethylene terephthalate, polyethylene naphthalate, or a silicone. The polymeric material may comprise a blend comprising at least one of the foregoing polymers. Mentioned for the first portion is a rigid, solid, or non-porous polymeric material such as a polycarbonate, polyamide, or an acrylonitrile-butadiene-styrene copolymer. Mentioned for the second portion is a polyurethane or a silicone.

The first portion 200 or the second portion 250 may each independently be in the form of a foam. In an embodiment, the first portion is a solid polymeric material, and the second portion is a foam. In an embodiment, the second portion comprises a viscoelastic foam. Mentioned is the use of a viscoelastic polyurethane foam for the second portion. The viscoelastic polyurethane may be a memory foam.

Alternatively, disclosed is the use of a gradient material in which the first portion 200 and the second portion 250 comprise a same material and the first portion 200 is solid and the second portion 250 is porous and the body comprises a gradient of increasing porosity in a direction from a center of the body towards an outer surface of the second portion 250. In an embodiment, the body comprises a single portion and the single portion comprises a gradient of porosity. The gradient of porosity may increase from the center of the body towards an outer surface of the body. In an embodiment, the porosity varies from 0 to 80%, 5 to 70%, or 10 to 60% in a direction from the center of the body towards outer surface of the body, wherein each end point is independently selectable. Use of silicone or polyurethane for the single portion is mentioned.

On an outer surface of the body, e.g., on the second portion 250, may be one or more additional portions. The one or more additional portions may comprise any suitable polymeric material, as mentioned above, and the additional portion may be in the form of a foam. In an embodiment, the bottom surface 150 comprises a rubbery material, such as silicone.

With reference now to FIG. 3, the cushion 100 may include at least one electromechanical vibrator mechanism capable of producing vibrations, also referred to herein as a vibrator mechanism 300. The at least one vibrator mechanism 300 is contained or embedded within the body. In an embodiment, all, or at least a portion of the vibrator mechanism 300 is positioned within the second portion 250 of the cushion 100. By positioning at least a portion of the vibrator mechanism 300 within an interior of the body, such as near an outer surface of the cushion 100 that the user is likely engage for example, facilitates the transmission of vibrations to the surface of the cushion. However, it should be appreciated that embodiments where at least a portion of the vibrator mechanism 300 is arranged at the interface between the first portion 200 and the second portion 250, and embodiments where the vibrator mechanism 300 is embedded in the first portion 200, are also contemplated herein. While only a single vibrator mechanism 300 is illustrated and described with respect to the cushion, it should be appreciated that embodiments including a plurality of vibrator mechanisms configured to operate at different times, such as in different modes, or alternatively, at the same time, such as during the same mode, for example, are within the scope of the disclosure.

Although the vibrator mechanism 300 is described herein as providing vibrations, it should be understood that vibrations are intended as an exemplary technique for providing external sensation to a body part. For example, the vibrator mechanism 300 capable of producing vibrations can provide stimulation, such as clitoral stimulation for example, using various techniques and technologies (e.g., at least one of vibration, oscillation, electrical stimulation, heat, cooling, or linear actuation). Further, as previously noted, the vibrations generated by the vibrator mechanism 300 are intended to provide a pleasurable experience for the user. In an embodiment, the vibrator mechanism 300 is operable at a frequency between 7000 Hertz (Hz) and 8500 Hz, or alternatively between 7000 Hz and 7500 Hz, 7000 Hz and 8000 Hz, 7500 Hz and 8500 Hz, 8000 Hz and 8500 Hz, for each of the foregoing endpoints maybe independently selected.

With continued reference to FIG. 3, in an embodiment, a rigid structure 305 is provided. The rigid structure may comprise a transmissible surface 308 on an outer surface of the body, such as at the top surface 160 of the cushion 100, for example. Although the transmissible surface 308 of the rigid structure 305 is illustrated as being exposed at the top surface 160 of the cushion 100 in FIG. 3, it should be appreciated that the rigid structure 305 may not be exposed and may be encapsulated within the second portion 250 of the cushion. For example, the rigid structure 305 may be arranged adjacent to, but not exposed at the top surface 160 of the cushion 100. However, embodiments where the rigid structure 305 is arranged at the interface between the first portion 200 and the second portion 250, or where the rigid structure 305 is arranged within or extends into the first portion 200 are also contemplated herein.

The overall shape of the rigid structure 305 may be complementary to an adjacent portion of the body. In the illustrated, non-limiting embodiment, the rigid structure 305 is the shape of a fin and may be curved to adapt to the first arcuate section 165 and/or a portion of the intermediate section 175. However, it should be appreciated that the rigid structure 305 may be arranged at or adjacent to any suitable portion of the cushion 100. Further, it should be appreciated that although only a single rigid structure 305 is illustrated and described herein, embodiments including a plurality of rigid structures that are separated from one another about the body are also within the scope of the disclosure. It should also be understood that embodiments of the cushion 100 that do not include a rigid structure 305 are also contemplated herein.

The substantially rigid structure 305 may be comprise any suitable transmissive material. In an embodiment, the rigid structure 305 is formed from a polymeric material including, but not limited a polymeric material as disclosed above for the first portion and the second portion. Mentioned for the rigid structure 305 is use of at least one of a polyolefin, such as a polyethylene or a polypropylene, a polyethylene terephthalate, a polyvinyl chloride, an acrylonitrile butadiene styrene-based material, a polyurethane, or a silicone. The rigid structure 305 may be in the form of a foam, gel, or rubber. Use of a solid silicone for the rigid structure 305 is also mentioned.

Because the material used to form the second portion 250 may have inherent vibration dampening properties, inclusion of the rigid structure 305 between the vibrator mechanism 300 and an outer surface of the cushion 100 is understood to improve the transmission of the vibrations experienced at the outer surface of the body, e.g., at the outer surface of the second portion.

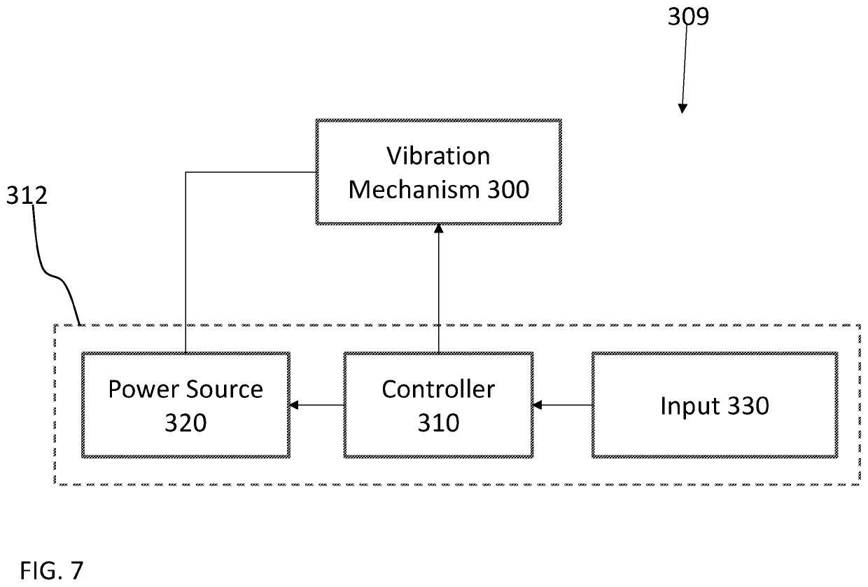

With reference to FIG. 7, and continued reference to FIGS. 1-6, an embodiment of a control system 309 of the cushion 100 is illustrated comprising a controller 310. The controller 310 may be configured to control operation of the vibrator mechanism 300. The controller 310 may include one or more of a microprocessor, microcontroller, application specific integrated circuit (ASIC), or any other form of electronic controller known in the art. The controller 310 may allow the user to select a mode of operation, such as the frequency or manner of vibration, and may be configured for selection between different modes.

In an embodiment, the controller 310 is arranged within a protective housing 312, illustrated schematically. The protective housing 312 may be embedded within an interior of the cushion 100, and may be within the first portion 200, within the second portion 250, or within both the first portion 200 and the second portion 250. In the non-limiting embodiment of FIGS. 1-3, the protective housing 312 is a separate enclosure, distinct from the vibrator mechanism 300. In such embodiments the protective housing 312 may be located adjacent to or may be located remotely from the vibrator mechanism 300. However, in other embodiments, best shown in FIG. 4-6, the vibrator mechanism 300 may be integrated into the protective housing 312 such that the cushion 100 includes a single enclosure containing both the vibrator mechanism 300 and the control system 309.

In an embodiment, the controller 310 is operable to selectively provide power from a power source 320, such as battery, to the vibrator mechanism 300. The power source 320 may be contained within the housing 312. In an embodiment, the power source 320 includes one or more batteries, such as a disposable battery, or a rechargeable battery. The rechargeable battery may be charged by connecting the cushion 100 to a wired or wireless electrical charging device. Alternatively, other suitable power sources can be used for providing the electrical power to the vibrator mechanism 300, such as a capacitor for example. In an embodiment, the power source 320 may be an external power source, such as a wall adapter, USB power, or external battery, connectable to the controller 310 via an electrical connector, such as a USB connector.

Also disclosed is an input 330. The input 330 may be integral to the cushion 100. The input 330 may provide for manual actuation or remote input. The input 330 may comprise a button, switch, or knob, for example, that is directly or indirectly connected to the controller 310 to allow the user to control operation of the vibrator mechanism 300. The input 330 may comprise a momentary touch, pressure sensitive, resistive or capacitive touch, or light-sensitive sensing mechanisms. In embodiments where the input 330 is configured to provide a remote input, the remote input may be configured to communicate with the controller 310 by any suitable means, such as by Bluetooth, wireless communication, near field communication, or radiofrequency communication. Alternatively, the remote input may be configured to communicate with the controller 310 through a cord.

Using the input 330, the user may be able to turn the vibrator mechanism 300 on or off, and the user may be able select the intensity of vibrations, e.g., by controlling the frequency or amplitude of the vibrations. For example, the input 330 may have a single button that when momentarily pressed sequentially causes the unit to go from off to low, low to medium, medium to high, high to off. Alternatively, the input 330 may comprise multiple buttons, with specified buttons for different operating functions, or a pressure sensitive touchscreen that users can operate to select the vibration intensity. Various sequences of presses and press durations of the one or more buttons may be programmed to perform different functions, such as on, off, slow, fast, reset, change operating or vibrating mode, or wireless device pairing. The number of times the user presses the input may also be used to adjust the various functions. In an embodiment, the at least one input 330 is arranged at or adjacent to the first end 110 of the cushion body, such as near the housing 312. However, those skilled in the art should appreciate that the one or more input 330 may be located at a variety of locations about the cushion 100.

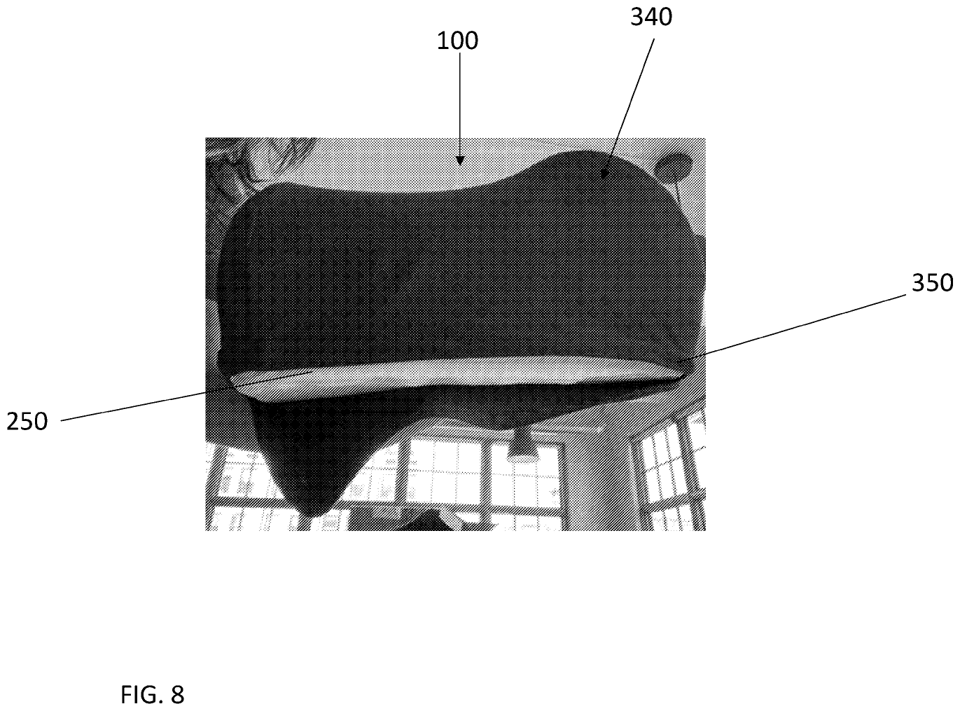

With reference to FIG. 8, the cushion 100 includes at least one cover, such as shown at 340, which may be removably or permanently installed about the outer surface of the cushion 100. In such embodiments, the cover 340 may be a pillowcase configured to encapsulate the cushion 100 when installed about the cushion 100. Alternatively, the cushion 100 may include a cover 340 permanently affixed to an outer surface of the second portion 250. In yet another embodiment, the cushion 100 includes a first cover and a second cover disposed in overlapping arrangement with the first cover, the second cover being removably positionable about the cushion 100. The first cover may be formed from a water-resistant material, and the second cover may alternatively or additionally, may be formed from a cotton, satin, jersey, polyester, or linen, or a combination thereof. In an embodiment, the second or outermost cover may include additional panels, seams, stitching, or embroidery that functions as an indicator to identify the location of, and facilitate the use of, the input 330.

In embodiments where the at least one cover 340 is removable, the cover 340and/or the cushion 100 may include a fastening mechanism 350 to retain the cover about the body of the cushion 100. In an embodiment, the fastening mechanism 350 includes a reversible closure, such a zipper or hook and loop fastener, to selectively open or close the cover. However, it should be understood that any suitable type of fastener, such as a snap, or buttons for example are also within the scope of the disclosure. In addition, although the fastener is illustrated as being arranged adjacent to the bottom surface 150 of the cushion body, it should be appreciated that a fastener may be located at any location, and in some embodiments, may be located at several positions about the cushion body.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

The endpoints of all ranges directed to the same component or property are inclusive of the endpoints, are independently combinable, and include all intermediate points and ranges.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cushion comprising:
a body comprising
a first portion comprising a first material, and
a second portion comprising a second material, wherein the second portion is arranged on an outer surface of the first portion;
a vibrator mechanism located at at least one of the first portion and the second portion, wherein the vibrator mechanism is operable to generate vibrations detectable at a region of an exterior surface of the second portion; and
a control unit operably coupled to the vibrator mechanism, the control unit being embedded within at least one of the first portion and the second portion.

2. The cushion of claim 1, wherein the second portion is directly on the outer surface of the first portion.

3. The cushion of claim 2, wherein the vibrator mechanism is adjacent to the second portion.

4. The cushion of claim 1, wherein the second material is a foam.

5. The cushion of claim 4, wherein the second material is a viscoelastic foam having an indentation load deflection of 40 ILD to 60 ILD.

6. The cushion of claim 1, further comprising a rigid structure at the exterior surface of the second portion, wherein the rigid structure comprises a transmissible surface.

7. The cushion of claim 1, wherein the control unit further comprises an input, the input being accessible via the exterior surface of the second portion.

8. The cushion of claim 1, wherein the control unit further comprises an input, the input being a remote input.

9. The cushion of claim 8, further comprising a cover removably mountable about the second portion.

10. The cushion of claim 9, wherein the cover has an indicator operable to identify a location of the input.

11. The cushion of claim 10, wherein the cover comprises at least one of a cotton, polyester, or linen.

12. A cushion comprising:
a body comprising a rigid structure, a portion of the rigid structure being located at an exterior of the body and comprising a transmissible surface; and
a vibrator mechanism located within the body, wherein the rigid structure is mechanically coupled to the vibrator mechanism such that vibrations generated by the vibrator mechanism are detectable at the transmissible surface; and
a control unit positioned within the body, the control unit being operably coupled to the vibrator mechanism.

13. The cushion of claim 12, wherein the body comprises a top surface, wherein the transmissible surface is located at the top surface.

14. The cushion of claim 12, wherein the rigid structure comprises a polymeric material.

15. The cushion of claim 12, wherein the rigid structure comprises at least one of a thermoplastic or a thermoset.

16. The cushion of claim 12, wherein the body comprises a first portion and a second portion on the first portion, wherein the second portion comprises a foam having an indentation load deflection of 40 ILD to 60 ILD.

17. The cushion of claim 16, wherein the second portion is a polyurethane foam.

18. A method of manufacturing a cushion, the method comprising:
providing a body comprising a first portion and a second portion, wherein the second portion is arranged on the first portion;
disposing a vibrator mechanism within at least one of the first portion or the second portion, wherein the vibrator mechanism is operable to generate vibrations detectable at a region of an outer surface of the second portion; and
coupling a control unit to the vibrator mechanism.
